(19) United States
(12) Patent Application Publication
(10) Pub. No.: US 2013/0255144 A1
(43) Pub. Date: Oct. 3, 2013

(54) Soil pressure sterilization method and apparatus

(71) Applicant: Michael Lee Lansdale, La Selva Beach, CA (US)

(72) Inventor: Michael Lee Lansdale, La Selva Beach, CA (US)

(21) Appl. No.: 13/506,195

(22) Filed: Apr. 3, 2012

(51) Int. Cl. A01B 77/00; A01B 79/00

(52) U.S. Cl. 47/1.42

(57) ABSTRACT

The present disclosure provides a method and apparatus for sterilization of soil in the field by pressure comprising grinding up soil using a rototilling mechanism, creating a pulverized soil; conveying the pulverized soil to a two-part holding container; and, transferring the pulverized soil from a lower section of the two-part holder container to a middle container which is operably linked to a pressurization mechanism, thereby allowing for the pulverized soil to be treated and sterilized with high pressure in the middle container resulting in a treated soil. The treated soil is then transferred to a transfer container being configured to shape a growing bed to a desired configuration using the treated soil which is deposited there.

### BACKGROUND OF THE INVENTION

1. Technical Field

This invention relates to methods and apparatuses for sterilizing soil in agriculture and horticultural businesses and practices, and more particularly, to both a method and apparatus for sterilizing soil in the field by pressure providing a replacement for chemical methods such as the use of methyl bromide and the like.

2. Background Art

The present invention is a method and apparatus for sterilizing soil in agriculture and horticultural businesses and practices which uses pressure to sterilize the soil in the field, and thus provides an environmentally clean and efficient replacement for chemical methods such as the use of methyl bromide and the like.

In all agricultural and horticultural businesses and practices, soil pathogens, weed seeds, nematodes, and microbes are an ever present problem. Numerous methods and apparatuses have been proposed and implemented in attempts to limit disease and crop loss due to soil pathogens, weed seeds, nematodes, and microbes. The principal prior means for soil sterilization are steam, heat, solarization, herbicides, and fungicides.

For example, heat has been used in a number of applications in the form of steam, heat chambers, flame apparatuses, and burners. However, a number of limitations arise when heat is used, primarily its expense, and problems with reliability and affordable application.

A wide variety of soil treatment chemicals, such as pesticides, herbicides, fungicides, and anti-microbials have also been proposed and implemented. Although some such treatments have limited usefulness, in all cases there is a trade-off with environmental contamination of the soil, the crops being grown in the soil, run-off water, and the like. Furthermore, many jurisdictions have now made the use of such chemicals illegal or have severely limited their use. For example, methyl bromide was a fairly efficient soil treatment method, but due to its toxicity is now banned in many areas. Currently chemical fumigation costs around $3500 per acre.

Solarization techniques have also been attempted to sterilize soil, where typically plastic sheets are used, or by connecting a series of tarpaulins with long-lasting heat resistant glue. However, these techniques are very expensive, often with the plastic or tarpaulins becoming brittle and tearing after long use, and are greatly limited when large acreages are involved.

Accordingly, there is a great need for a clean, efficient, and inexpensive way to sterilize soil in the field and other growing mediums in agriculture and horticulture businesses and practices. The present invention provides, for the first time a method and apparatus for soil sterilization which uses pressure to sterilize the soil or other growing medium. The method and apparatus disclosed herein, is efficient, reliable, cost-effective, and environmentally friendly. It is effective to control many soil pathogens such as fungi, bacteria, and specific weeds, and specifically is very useful to control verticillium, nematodes, weed seeds and the like.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF SUMMARY OF THE INVENTION

To achieve the foregoing objects, and in accordance with the purpose of the invention as embodied and broadly described herein, the present disclosure provides a method and apparatus for the sterilization or partial sterilization of soil in the field by pressure comprising grinding up soil using a rototilling mechanism, creating a pulverized soil; conveying the pulverized soil to a two-part holding container, the two-part holding container has an upper section and a lower section, the upper section and the lower section of the two-part holding container having a dividing element allowing for the controlled movement of pulverized soil; and, transferring the pulverized soil from the lower section of the two-part holder container to a middle container which operably is linked to a pressurization mechanism, thereby allowing for the pulverized soil to be treated and sterilized with high pressure in the middle container resulting in a treated soil. The treated soil is then transferred to a transfer container being configured to shape a growing bed to a desired configuration using the treated soil which is deposited there.

The preferred apparatus of the present invention, for partial or complete soil sterilization comprises, in one embodiment, a rototilling mechanism for grinding up soil, a two-part holding container, the two-part holding container comprising an upper section and a lower section, the upper section and the lower section of the two-part holding container having a dividing element allowing for the controlled movement of the soil from the upper section to the lower section of the two-part holding container. A middle container is operably linked to the two-part holding container, and being operably linked to a pressurization mechanism, thereby allowing for the soil to be treated and sterilized with high pressure in the middle container resulting in a treated soil. A transfer container is provided being configured to shape a growing bed to a desired configuration using the treated soil which is deposited there. The energy required to pressurize the middle container may come from a tractor which may also pull the apparatus, or from a separate engine.

### BRIEF DESCRIPTION OF THE DRAWINGS

The accompanying drawings, which are incorporated in and constitute a part of this specification, illustrate a preferred embodiment of the invention and, together with a general description given above and the detailed description of the preferred embodiment given below, serve to explain the principles of the invention.

FIG. 1, shows a preferred embodiment of an apparatus for partial or total sterilization of soil using pressure, according to the invention.

FIG. 2, shows another preferred embodiment of an apparatus for partial or total sterilization of soil using pressure, according to the invention.

FIG. 3, is a flow diagram of an exemplary embodiment of the soil sterilization method, according to the invention.

FIG. 4, is a flow diagram of another exemplary embodiment of a method for partial or complete soil sterilization, according to the invention.

### DETAILED DESCRIPTION OF THE INVENTION

Reference will now be made in detail to the present preferred embodiments of the invention as illustrated in the accompanying drawings. In the following description of the present invention, reference is made to the accompanying drawings which form a part thereof, and in which is shown by way of illustration, exemplary embodiments illustrating the principles of the present disclosure and how it may be practiced. It is to be understood that other embodiments may be utilized and structural changes may be made thereto without departing from the scope of the present disclosure.

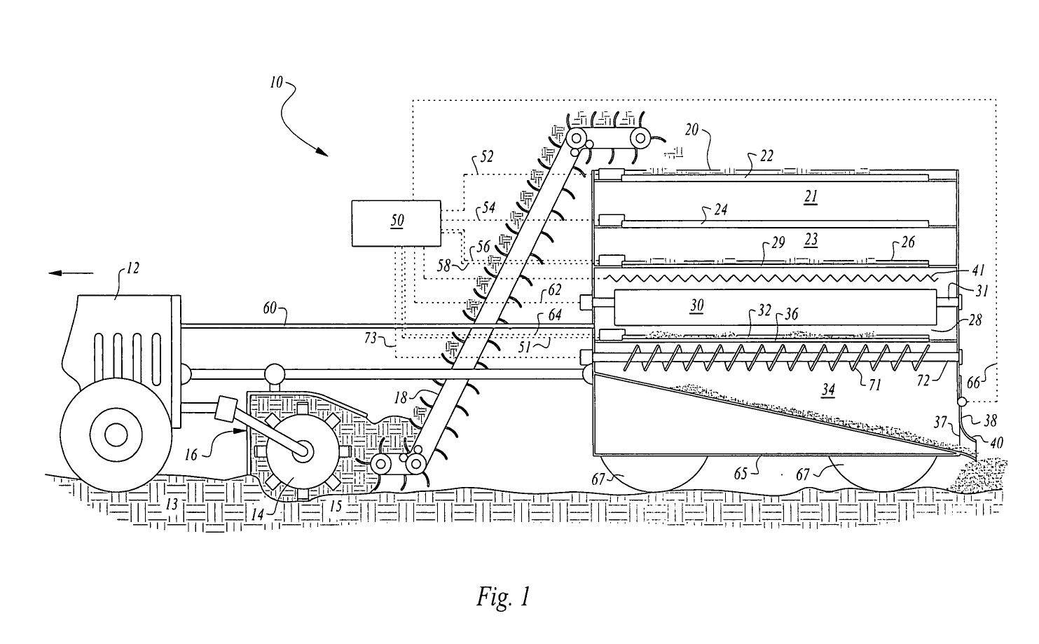

In accordance with the present invention, as seen in FIG. 1, there is provided in a preferred embodiment of the invention, an apparatus for partial or complete soil sterilization in the field, comprising a rototilling mechanism 16, which may be attached to rototiller 14, or tractor 12, for grinding up soil 13, in growing bed 15, which may be any soil used for growing agricultural or horticultural crops and produce. Soil 13, from growing bed 15, is ground or broken up to a pulverized state by rototilling mechanism 16, and then conveyed by conveyor 18, to a two-part holding container 20, the two-part holding container comprising an upper section 21 with upper sliding door 22, controlled by control wire 52, and a lower section 23, with sliding door 24, controlled control wire 54. Although in FIG. 1 control wires are shown for control of sliding door 22 and 24, wireless control means may also be used in different embodiments. Upper section 21, and lower section 23, of the two-part holding container 20, preferably has a dividing element comprising sliding door 24, allowing for the controlled movement of soil 13, from the upper section 21, to the lower section 23, of the two-part holding container 20.

In FIG. 1 a middle container 28, has a sliding door 26 operably controlled by control wire 56, and is operably linked to the two-part holding container 20, so that soil in upper section 21, of container 20, fills the lower section of the container 23, is filled with soil, sliding door closes to upper section 21. Alternatively, wireless control mechanisms may replace control wire 56, in other embodiments. This assures a constant supply of soil which drops by gravity through lower plate 26, of upper two-part container 20, to middle container 28. Preferably, lower section 23, of two-part container 20, holds the same volume of soil as middle container 28, and once the middle container is emptied after pressure treatment more soil drops into middle container 28, filling it for treatment.

Middle container 28, is operably connected to a pressurization mechanism which may be a pressure hose 60, powered from tractor 12, a compressor, or from a separate engine. When door 29, which is preferably a sliding type door, and controlled by control wire 58, communicatively linked to control panel 50, closes, pressurization of middle container 28, may begin, thereby allowing for the soil to be treated and sterilized with high pressure in said middle container resulting in a treated soil. Depending on whether partial or complete sterilization is desired pressure within middle container 28, can be adjusted, from lower pressures to hundreds of times or more atmospheric pressure, if certain microbes and pathogens are to be eliminated. A wireless control mechanism can replace control wire 58, in other embodiments.

In certain embodiments, and as seen in FIG. 1, a rotating half-drum or cylindrical centrifuge 30, may be operably secured within middle container 28, with axle 31 operably linked to control wire 62, for controlled rotation of rotating half-drum or cylindrical centrifuge 30. A wireless control mechanism may be substituted for control wire 62, in other embodiments. Cylindrical centrifuge or half-drum 30, may be used to circulate and slowly drop the soil within middle chamber 28, when pressurized, thereby subjecting the entire soil volume to an equal amount of the force of the pressure as the soil dribbles downwards from the lip of rotating half drum or cylindrical centrifuge 30. Lower door or panel 32, of middle container 28 is controlled by wire 64, operably linked to control panel 50, for opening and closing to release tread soil into a lower or transfer container 34. Wire 64, may be replaced by a wireless control mechanism in other embodiments.

Transfer container 34, is preferably configured with upper sliding door or panel 36, with control wire 51, and receives the sterilized soil from middle container 28. Transfer container 34 preferably has aperture or opening 37, with door 38, controlled by control wire 66, operably linked to control panel 50. Control wire 66, can be replaced by a wireless control mechanism, in other embodiments. Transfer container 34, is preferably configured to shape a growing bed to a desired configuration, using growing bed shaper 40, which may be wedge, plow shaped, or any other configuration desired, so as the treated soil is deposited, a desired configuration of growing bed in created with the treated soil. Soil grinding mechanism, soil grinder 71, may be operably positioned in transfer container 34. Grinder 71, is used to break up the pressurized treated soil which may crust or clump up. Soil grinder 71, is preferably positioned near the top of transfer container 34, and has mount/axle 72, operably connected to control and power wire 73.

Preferably, if middle container holds, for example, X volume of soil, upper container 20, and transfer container 34, would be sized to hold plus or minus 5 times the amount of soil as middle container 28. This allows the entire apparatus 10, to maintain a steady forward movement, when moved by tractor 12, or when a separate engine is used. The forward movement speed will be determined by how much time the pressurization chamber requires to kill the pathogens.

It is seen in FIG. 1, that apparatus 10, both the rototilling or soil grinding mechanism 14 and 16, is powered by tractor 12, as is pressurization hose 60, to middle container 28.

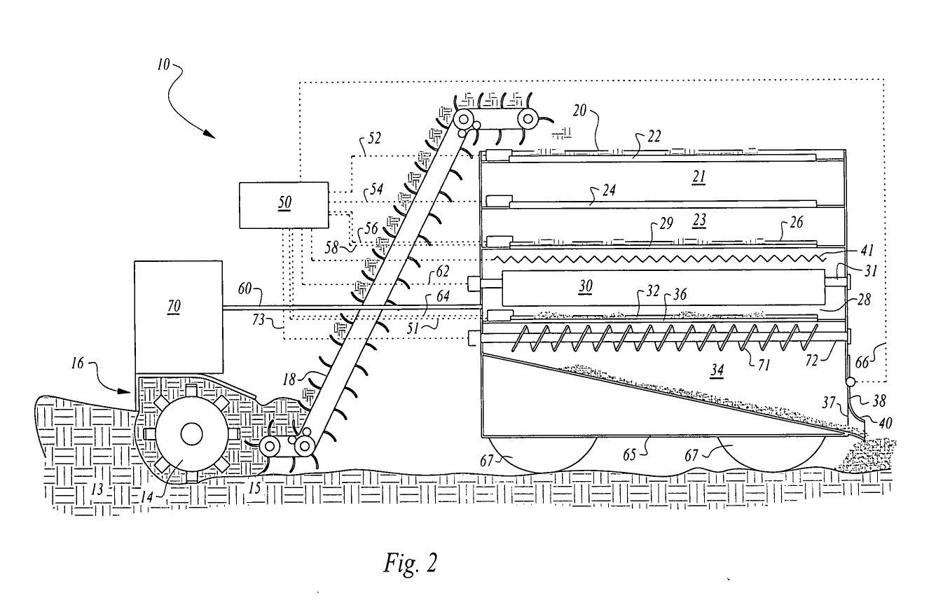

In FIG. 2 it is seen that apparatus 10, both the rototilling or soil grinding mechanism 14 and 16, is powered by separate engine and compressor 70, as is pressurization hose 60, to middle container 28. This embodiment using a separate engine 70, is useful, for example in the nursery industry where soil and other growing mediums being treated by the method and apparatus of the present invention are of smaller scale and do not require movement by a tractor as would be the case in an agricultural application.

Seen in FIGS. 1 and 2, apparatus 10, with middle container 28, includes a heat element 41, operably secured therein, for providing heat if needed to enhance the sterilization process. This is useful in situations where heat is need in addition to pressure to eradicate particular organisms or weed seeds in the soil.

Apparatus 10, may be housed in housing 65, as shown in FIGS. 1 and 2, with wheels 67, allowing for ease of movement, or may be provided in modular or unit form as seen in FIG. 1. Housing 65, is preferably composed of a durable resilient material such as metal, composite, plastic, or the like.

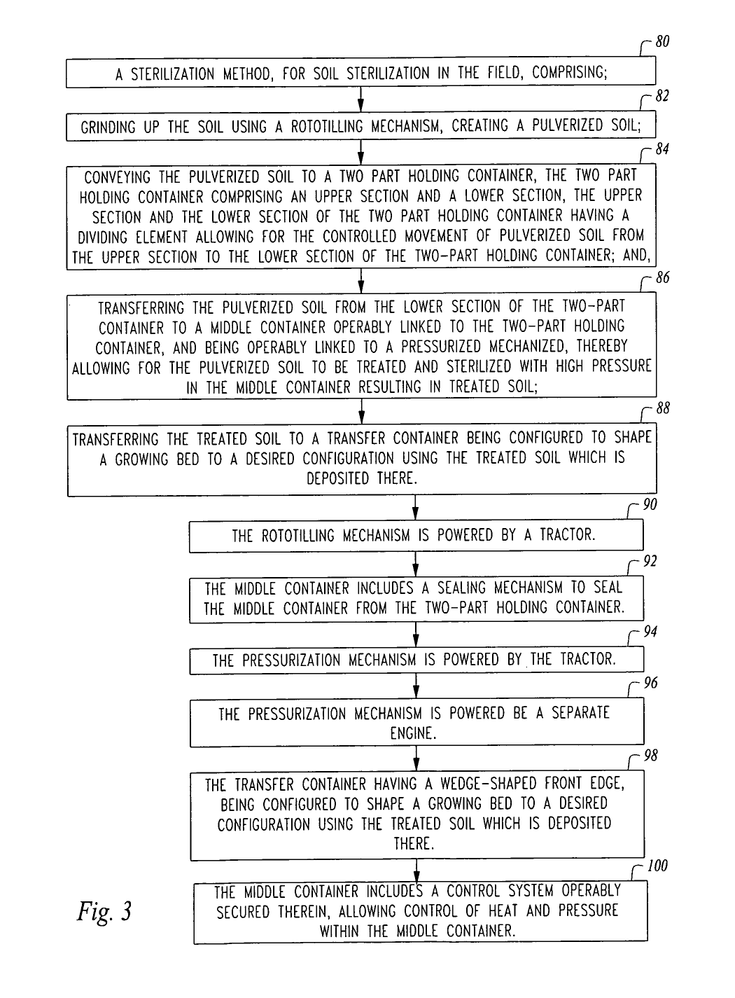

With reference now to FIG. 3 a soil sterilization method 80, for soil sterilization in the field, is shown comprising the steps of: First, grinding up soil using a rototilling mechanism, creating a pulverized soil 82: Conveying the pulverized soil to a two-part holding container, the two-part holding container comprising an upper section and a lower section, the upper section and said lower section of the two-part holding container having a dividing element allowing for the controlled movement of pulverized soil from the upper section to the lower section of the two-part holding container 84. The pulverized soil is then transferred from the lower section of the two-part holder container to a middle container operably linked to the two-part holding container, and being operably linked to a pressurization mechanism, thereby allowing for the pulverized soil to be treated and sterilized with high pressure in the middle container resulting in a treated soil 86. Preferably, the treated soil is then transferred to a transfer container being configured to shape a growing bed to a desired configuration using the treated soil which is deposited there 88.

In the preferred method, shown in FIG. 3, the rototilling mechanism may be powered by a tractor 90, or a separate engine, or poser source. Preferably, the middle container includes a sealing mechanism to seal the middle container from the two-part holding container 92. In the preferred method, the pressurization mechanism is powered by a tractor 94, or alternatively, the pressurization mechanism is powered by a separate engine 96.

In FIG. 3, the transfer container preferably has a wedge-shaped front edge, being configured to shape a growing bed to a desired configuration using the treated soil which is deposited there 98, but may be otherwise configured. Preferably, middle container includes a control system operably secured therein, allowing control of heat and pressure within the middle container 100.

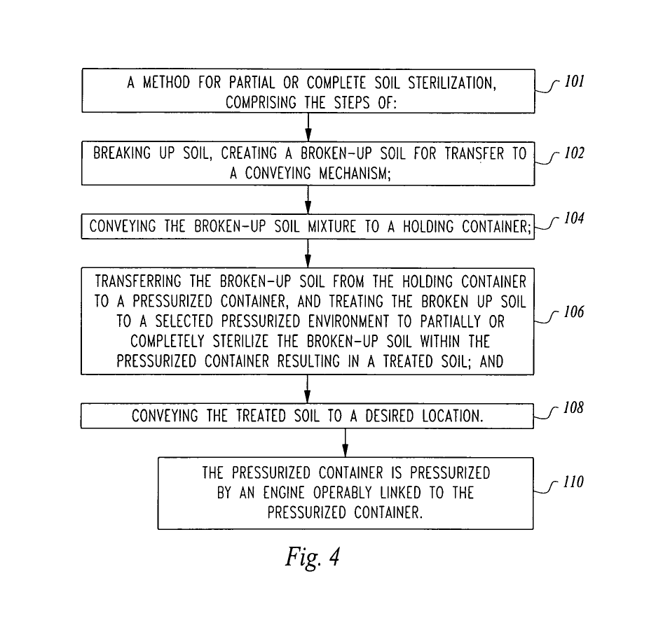

In FIG. 4 another preferred method for partial or complete soil sterilization 101, is shown, comprising the steps of: First, breaking-up soil, creating a broken-up soil for transfer to a conveying mechanism 102. Then conveying the broken-up soil mixture to a holding container 104. Next, the broken up or pulverized soils is transferred from the holding container to a pressurized container, and treating the broken up soil to a selected pressurized environment to partially or completely sterilize the broken-up soil within the pressurized container resulting in a treated soil 106. The treated soil is then conveyed to a desired location 108. The pressurized container is preferably pressurized by an engine operably linked to the pressurized container, or by a tractor engine or the like, 110.

In operation and use apparatus 10, and the methods described herein, provide for a clean, efficient, and inexpensive way to sterilize or partially sterilize soil in the field, and other growing mediums in agriculture and horticulture businesses and practices, both large and small scale. The present invention provides, for the first time a method and apparatus 10, for soil sterilization which uses pressure to sterilize the soil or other growing medium. The method and apparatus described herein may be used in combination with heat, as provided by heat element 41, or in some circumstances with chemicals such as fungicides, insecticides, herbicides and the like, albeit, at far lower concentrations than conventionally required. The method and apparatus 10, disclosed herein, is efficient, reliable, cost-effective, and environmentally friendly. It is effective to control many soil pathogens such as fungi, bacteria, and weeds, and the like, and specifically is very useful to control pests such verticillium, nematodes, and weed seeds. Apparatus 10, may be used and powered by a tractor 12, or separate engine and compressor 70, and may be variously configured for different applications, larger for agricultural operations and smaller versions for horticultural or small scale farms, and organic farms.

Additional advantages and modification will readily occur to those skilled in the art. The invention in its broader aspects is, therefore, not limited to the specific details, representative apparatus and illustrative examples shown and described. For examples various type of compressors and engines to power the compressors may be used to pressurize and treat the soil, manual mechanisms may be substituted for the wire or wireless controls on the different doors and openings, and numerous housing configurations may be used. Accordingly, departures from such details may be made without departing from the spirit or scope of the applicant's general inventive concept.

What is claimed is:

1. A soil sterilization method, for soil sterilization in the field, comprising:
grinding up soil using a rototilling mechanism, creating a pulverized soil;
conveying said pulverized soil to a two-part holding container, said two-part holding container comprising an upper section and a lower section, said upper section and said lower section of the two-part holding container having a dividing element allowing for the controlled movement of pulverized soil from the upper section to the lower section of the two-part holding container; and,
transferring the pulverized soil from the lower section of the two-part holder container to a middle container operably linked to the two-part holding container, and being operably linked to a pressurization mechanism, thereby allowing for the pulverized soil to be treated and sterilized with high pressure in said middle container resulting in a treated soil; and
transferring said treated soil to a transfer container being configured to shape a growing bed to a desired configuration using the treated soil which is deposited there.

2. The soil sterilization method of claim 1, wherein said rototilling mechanism is powered by a tractor.

3. The soil sterilization method of claim 1, wherein said middle container includes a sealing mechanism to seal the middle container from said two-part holding container.

4. The soil sterilization method of claim 2, where said pressurization mechanism is powered by said tractor.

5. The soil sterilization method of claim 2, where said pressurization mechanism is powered by a separate engine.

6. The soil sterilization method of claim 1, wherein said transfer container has a wedge-shaped front edge, being configured to shape a growing bed to a desired configuration using the treated soil which is deposited there.

7. The soil sterilization method of claim 1, wherein said middle container includes a control system operably secured therein, allowing control of heat and pressure within the middle container.

8. A method for partial or complete soil sterilization, comprising the steps of:
breaking-up soil, creating a broken-up soil for transfer to a conveying mechanism;
conveying said broken-up soil mixture to a holding container;
transferring the broken-up soil from the holding container to a pressurized container, and treating the broken-up soil to a selected pressurized environment to partially or completely sterilize the broken-up soil within the pressurized container resulting in a treated soil; and
conveying the treated soil to a desired location.

9. The method for partial or complete soil sterilization of claim 8, wherein said pressurized container is pressurized by an engine operably linked to said pressurized container.

10. An apparatus for partial or complete soil sterilization in the field, comprising:
a rototilling mechanism for grinding up soil,
a two-part holding container, said two-part holding container comprising an upper section and a lower section, said upper section and said lower section of the two-part holding container having a dividing element allowing for the controlled movement of said soil from the upper section to the lower section of the two-part holding container;
a middle container operably linked to the two-part holding container, and being operably linked to a pressurization mechanism, thereby allowing for the soil to be treated and sterilized with high pressure in said middle container resulting in a treated soil; and
a transfer container, said transfer container having a soil grinder mechanism operably secured therein, and is configured to shape a growing bed to a desired configuration using the treated soil which is deposited there.

11. The apparatus of claim 10, wherein said rototilling mechanism is powered by a tractor.

12. The apparatus of claim 10, wherein said middle container includes a sealing mechanism to seal the middle container from said two-part holding container.

13. The apparatus of claim 11, where said pressurization mechanism is powered by said tractor.

14. The apparatus of claim 12, where said pressurization mechanism is powered by a separate engine.

15. The apparatus of claim 10, wherein said transfer container has a wedge-shaped front edge, being configured to shape a growing bed to a desired configuration using the treated soil which is deposited there.

16. The apparatus of claim 10, wherein said middle container includes a control system operably secured therein, allowing control of heat and pressure within the middle container.

17. The apparatus of claim 10, wherein said middle container includes a rotatable half-drum therein, thereby allowing the entire soil volume to be subject to an equal amount of force from the pressure within the middle container.

18. The apparatus of claim 10, wherein said middle container includes a cylindrical centrifuge therein, thereby allowing the entire soil volume to be subject to an equal amount of force from the pressure within the middle container.

19. The apparatus of claim 10, further including a housing for enclosure of said two-apart holding container, said middle container, and said transfer container, said housing having one or more wheels operably attached thereto.
